(19) United States
(12) Patent Application Publication
(10) Pub. No.: US 2016/0200559 A1
(43) Pub. Date: Jul. 14, 2016

(54) Fork Lift Shield

(71) Applicant: Arrow Acquisition, LLC, Lenexa, KS (US)

(72) Inventors: Terrence S. Melvin, Lenexa, KS (US); Ross T. Gault, Lenexa, KS (US)

(21) Appl. No.: 14/596,742

(22) Filed: Jan. 14, 2015

(51) Int. Cl. B66F 9/12

(52) U.S. Cl. CPC B66F 9/12

(57) ABSTRACT

A shield for protecting an inner curved portion of a single fork of a fork lift from damage during operation of the fork lift.

This invention pertains to a shield for protecting an inner curved portion of a single fork of a fork lift from damage during operation of the fork lift.

### BRIEF DESCRIPTION OF THE DRAWINGS

The following drawings illustrate the concepts of the present invention, and are not necessarily drawn to scale.

FIG. 1 is a perspective view of a generic fork of a fork lift.

FIG. 2 is a perspective view of an embodiment of a fork lift shield installed on a fork of a fork lift.

FIG. 3 is a left front perspective view of an embodiment of a fork lift shield.

FIG. 4 is a right rear perspective view of the embodiment of FIG. 3.

FIG. 5 is a right front perspective view of the embodiment of a fork lift shield of FIG. 2, including mounts, bolts and a fastening bar.

FIG. 6 is a right rear perspective view of the embodiment of FIG. 5.

FIG. 7 is a perspective view of an embodiment of a fork lift shield installed on a fork of a fork lift.

FIG. 8 is a right rear perspective view of the embodiment of FIG. 7.

FIG. 9 is a right front perspective view of an embodiment of a fork lift shield, including a mounting strap.

FIG. 10 is right side perspective view of the embodiment of FIG. 9.

FIG. 11 is a right rear perspective view of the embodiment of FIG. 9.

### DETAILED DESCRIPTION OF SOME EMBODIMENTS

While the present invention is susceptible of embodiment in various forms, there is shown in the drawings and will hereinafter be described some embodiments with the understanding that the present disclosure is to be considered an exemplification of the invention and is not intended to limit the invention to the specific embodiments illustrated or described.

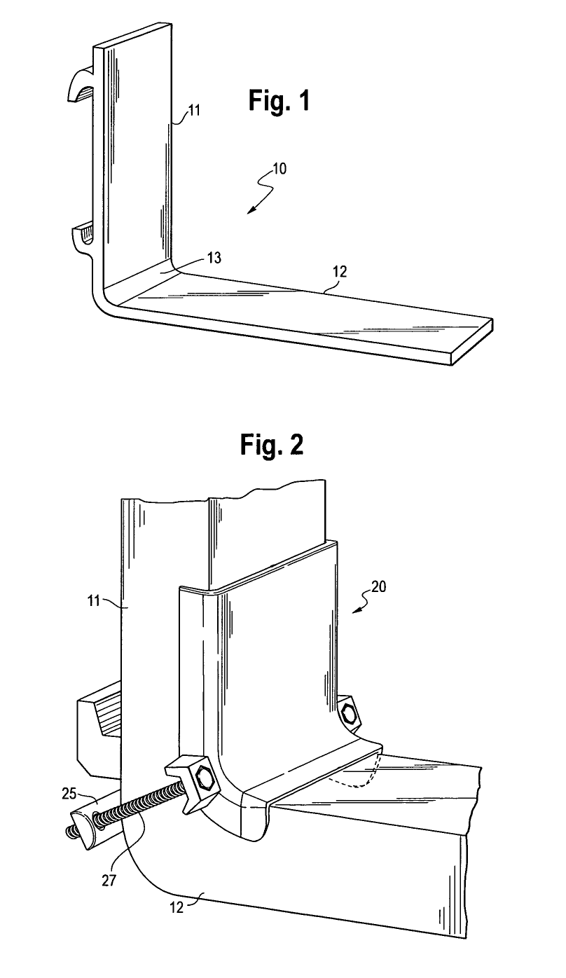

Forks of fork lifts are designed to meet certain capacity ratings based on the stresses anticipated in critical sections of the geometry when the rated capacity is applied to the fork. FIG. 1 illustrates a fork 10 of a fork lift. It includes a vertical part 11 for attachment to a fork lift vehicle, and a horizontal part 12 that is inserted underneath a load during operation of the fork lift. The front of the vertical part 11 transitions to the top of the horizontal part 12 at an inner curved portion 13. That inner curved portion 13 is a high stress area that typically experiences the stress level that governs the rated capacity for the fork 10.

The two primary failure modes for the inner curved portion 13 are 1) rupture due to significant overload, and 2) fatigue crack propagation followed by rupture due to the reduced cross-section of the fork 10 resulting from the fatigue cracks. Providing capacity ratings, industry standards, and OSHA regulations requiring observance of those ratings are measures taken to avoid rupture due to significant overload. Fatigue cracks may occur due to manufacturing defects, and attempts are made to engineer such manufacturing defects out of the production process. However, fatigue cracks also may occur from damage incurred during use, and such damage is difficult to control.

As shown in FIG. 2, a fork lift shield 20 may be installed to protect the inner curved portion 13 of a fork 10 from damage that may be incurred during operation of the fork lift, thereby extending the useful life of the fork 10. A fork lift shield may be composed of various materials, as is known in the art, such as rubber, steel, ductile iron, plastic, and so forth.

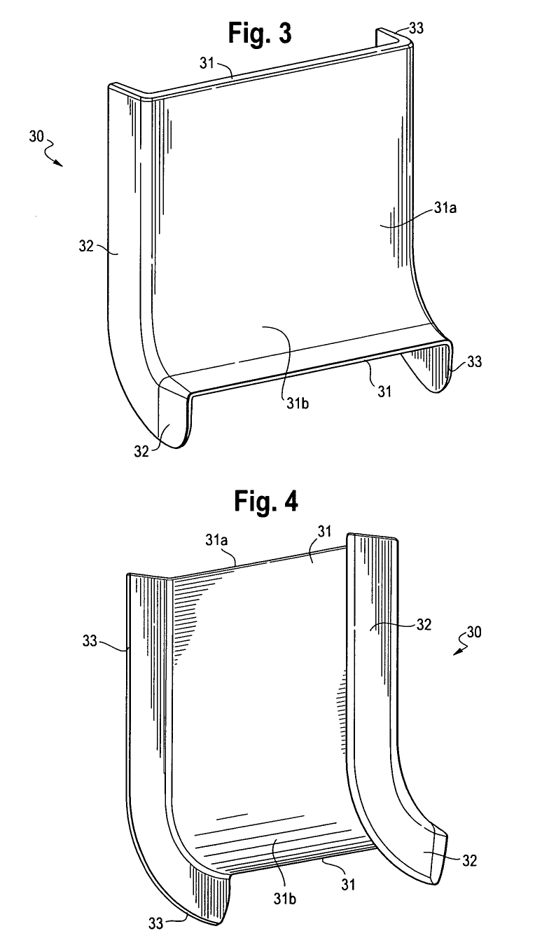

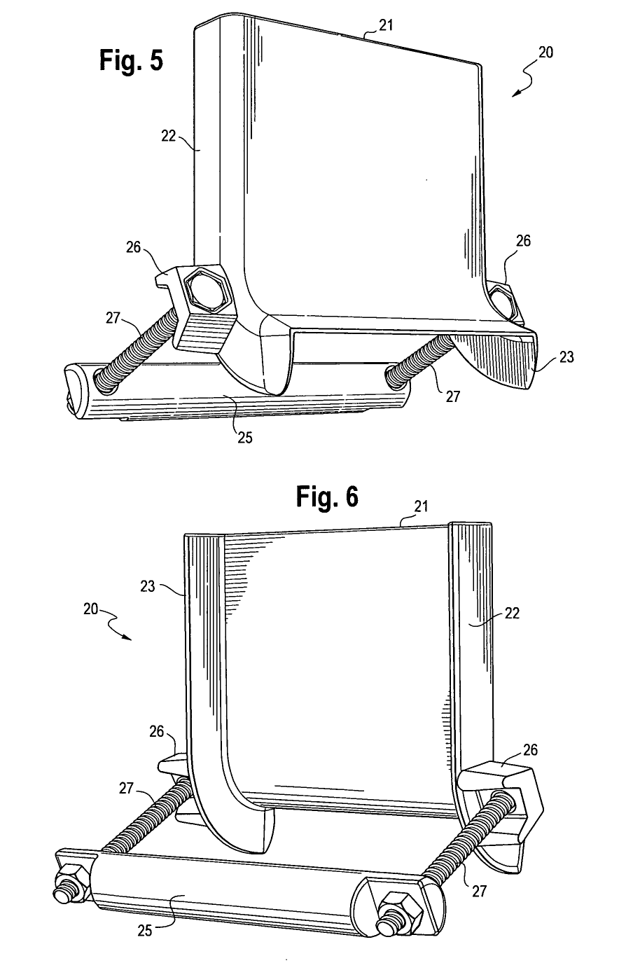

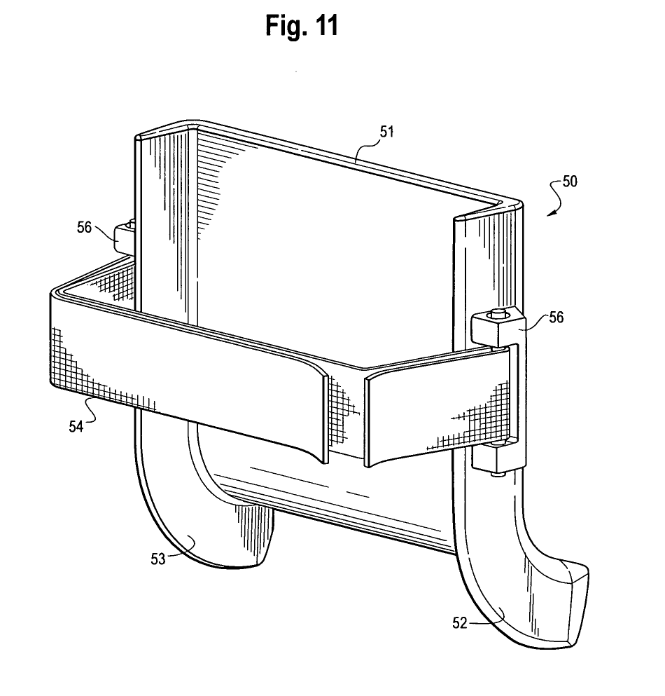

Several embodiments of a fork lift shield are shown in FIGS. 3-11. A right front perspective view and a right rear perspective view of the fork lift shield 20 of FIG. 2 are shown in FIGS. 5 and 6, respectively. It has a center portion 21 of generally constant width that is dimensioned to fit against the inner curved portion 13 of a fork 10. It has left and right generally vertical planar side portions 23 and 22, that are generally perpendicular to the center portion 21, and that are joined, respectively, all along the left and right sides of the center portion 21. The generally constant width of the center portion 21 is selected so that inner surfaces of the left and right side portions 23 and 22 are adjacent to left and right sides, respectively, of a single fork 10 when the fork shield 20 is installed in front of the inner curved portion 13 of the fork 10.

In the embodiment of FIGS. 2, 5 and 6, there are mounts 26 joined to outer surfaces of the left and right side portions 23 and 22. Bolts 27 extend between the mounts 26 and a fastening bar 25. When installed on a fork 10, the fastening bar 25 is positioned behind the vertical portion 11 of the fork 10 and the bolts are tightened to retain the center portion 21 of the fork lift shield 20 against the inner curved portion 13 of the fork 10. Fastening bar 25 is illustrated as a modified cylinder, but it could be any of a variety of shapes such as, for example, flat, round, cupped, and so forth. The bolts 27 are illustrated as two bolts holding a fastening bar to mounts on the left and right side portions 23 and 22, but other options can be used. For example, a U-bolt can be positioned behind the vertical portion 11 of the fork 10 instead of a fastening bar, and ends of the U-bolt can engage mounts on the left and right side portions 23 and 22. As another example, there can be additional fork mounts on the left and right sides of the fork 10, and bolts can extend between the respective additional fork mounts and respective mounts on the left and right side portions 23 and 22.

A right front perspective view and a right rear perspective view of another embodiment of a fork lift shield 30 are shown in FIGS. 3 and 4, respectively. It similarly has a center portion 31 and left and right side portions 33 and 32. The center portion 31 similarly has a generally vertical planar part 31a and a curved part 31b at the bottom of the vertical part 31a, with the curved part 31b curving from being generally vertical at the bottom of the vertical part 31a to being more horizontal than vertical at a bottom of the curved part 31b. This embodiment is different than the embodiment of FIGS. 5 and 6 in the way it is installed on a fork 10. It does not have the mounts 26 and is not bolted to the fork 10. Instead, it is applied with a bonding agent such as an epoxy or another construction adhesive.

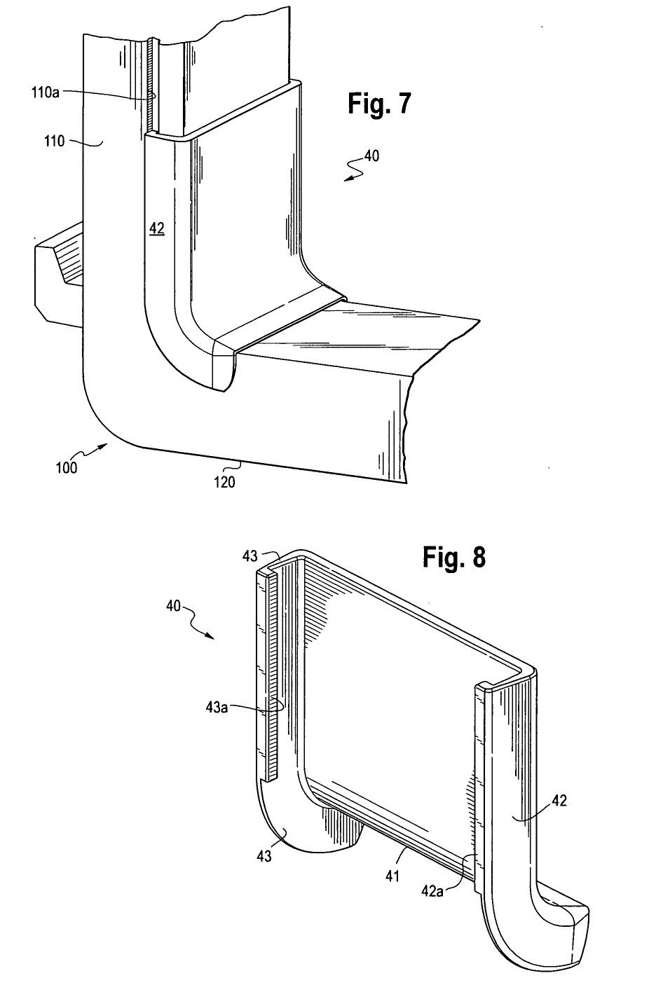

FIG. 7 is a perspective view of another embodiment of a fork lift shield 40 installed on a fork 100, and FIG. 8 is a right rear perspective view of the fork lift shield 40 of FIG. 7. Again, it has a center portion 41 and left and right side portions 43 and 42. However, there are vertical grooves or recesses 110a in the sides of the vertical part 110 of the fork 100, and there are corresponding vertical protrusions 43a and 42a along inner surfaces of the left and right side portions 43 and 42. In this embodiment, it can be seen that the fork lift shield 40 is installed on the fork 100 by sliding the fork lift shield 40 down over the vertical part 110, with the protrusions 43a and 42a fitting in the recesses 110a. In other examples, the recesses and protrusions may be interchanged, so that the fork has the protrusions and the fork lift shield has the recesses; the recesses and protrusions may be only on one side instead of on both sides; the recesses or protrusions may be on the horizontal part 120 of the fork; the fork lift shield may be sufficiently flexible and resilient to permit snap fastening instead of slide fastening; and so forth.

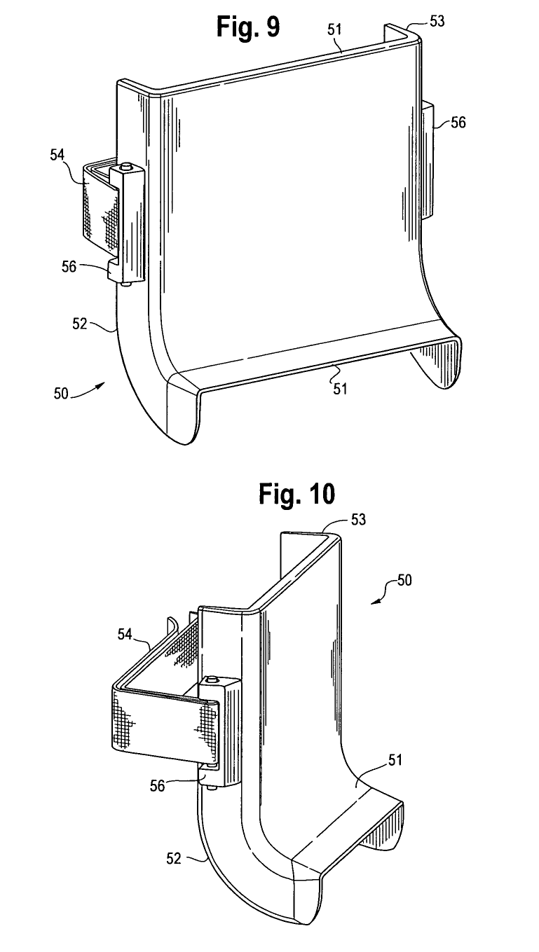

Right front, side, and rear perspective views of another embodiment of a fork lift shield 50 are shown in FIGS. 9-11, respectively. It similarly has a center portion 51 and left and right side portions 53 and 52. This embodiment is different than the embodiment of FIGS. 5 and 6 in the way it is installed on a fork 10. It has mounts 56 joined to outer surfaces of the left and right side portions 53 and 52. A strap 54 is attached to the mounts 56. When installed on a fork 10, the strap 54 is positioned behind the vertical portion 11 of the fork 10 and the strap 54 is tightened to retain the center portion 51 of the fork lift shield 50 against the inner curved portion 13 of the fork 10. In the example illustrated in FIGS. 9-11, strap 54 uses a hook-and-loop type of fastener. Other fasteners could be used, such as other snap, hook, button, or buckle fasteners, for example.

Fork lift shields 20, 30, 40 and 50 are examples of means for shielding the inner curved portion of a single fork of a fork lift. Bolting, bonding, slide fastening, snap fastening, and strapping are examples of means for installing such a shielding means in front of the inner curved portion of a single fork of a fork lift.

From the foregoing, it will be understood that numerous modifications and variations can be effectuated without departing from the true spirit and scope of the novel concepts of the present invention. It is to be understood that no limitation with respect to the specific embodiments illustrated and described is intended or should be inferred.

What is claimed is:

1. A fork lift shield for protecting from damage an inner curved portion of a single fork of a fork lift, the fork lift shield comprising:
a center portion of generally constant width, the center portion comprising a generally vertical planar part and a curved part at a bottom of the vertical part, the curved part curving from being generally vertical at the bottom of the vertical part to being more horizontal than vertical at a bottom of the curved part; and
left and right generally vertical planar side portions, the left and right side portions being generally perpendicular to the center portion, being joined, respectively, to left and right sides of the center portion, and extending from a top of the vertical part to the bottom of the curved part;
wherein the generally constant width of the center portion is selected so that inner surfaces of the left and right side portions are adjacent to left and right sides, respectively, of the single fork when the fork lift shield is installed in front of the inner curved portion of the single fork.

2. The fork lift shield as in claim 1, wherein an inner surface of at least one of the left and right side portions comprises a protrusion that is structured and dimensioned to fit in a recess in the left or right side, respectively, of the single fork, when the fork lift shield is installed in front of the inner curved portion of the single fork.

3. The fork lift shield as in claim 1, wherein an inner surface of at least one of the left and right side portions comprises a recess that is structured and dimensioned to receive a protrusion formed in the left or right side, respectively, of the single fork, when the fork lift shield is installed in front of the inner curved portion of the single fork.

4. The fork lift shield as in claim 1, further comprising strap fasteners for strapping the fork lift shield to the single fork.

5. The fork lift shield as in claim 1, further comprising:
at least one mount joined to an outer surface of the left side portion;
at least one mount joined to an outer surface of the right side portion;
a fastening bar; and
bolts extending between the fastening bar and the respective mounts, the bolts being long enough so that the fastening bar can be positioned behind the single fork when the fastening bar is bolted to the mounts and the fork lift shield is installed in front of the inner curved portion of the single fork.

6. The fork lift shield as in claim 1, further comprising:
at least one mount joined to an outer surface of the left side portion;
at least one mount joined to an outer surface of the right side portion; and
a U-bolt, the U-bolt being long enough so that it can be positioned behind the single fork when ends of the U-bolt are engaged with the respective mounts and the fork lift shield is installed in front of the inner curved portion of the single fork.

7. The fork lift shield as in claim 1, further comprising:
at least one shield mount joined to an outer surface of the left side portion;
at least one shield mount joined to an outer surface of the right side portion;
at least one fork mount joined to the left side of the single fork;
at least one fork mount joined to the right side of the single fork; and
bolts extending between the respective shield mounts and the respective fork mounts.

8. The fork lift shield as in claim 1, wherein the fork lift shield is composed at least in part of rubber.

9. The fork lift shield as in claim 1, wherein the fork lift shield is composed at least in part of steel.

10. The fork lift shield as in claim 1, wherein the fork lift shield is composed at least in part of ductile iron.

11. The fork lift shield as in claim 1, wherein the fork lift shield is composed at least in part of plastic.

12. A method for protecting an inner curved portion of a single fork of a fork lift from damage during operation of the fork lift, the method comprising:
providing a fork lift shield, the fork lift shield comprising:
a center portion of generally constant width, the center portion comprising a generally vertical planar part and a curved part at a bottom of the vertical part, the curved part curving from being generally vertical at the bottom of the vertical part to being more horizontal than vertical at a bottom of the curved part; and
left and right generally vertical planar side portions, the left and right side portions being generally perpendicular to the center portion, being joined, respectively, to left and right sides of the center portion, and extending from a top of the vertical part to the bottom of the curved part; and
installing the fork lift shield in front of the inner curved portion of the single fork, so that inner surfaces of the left and right side portions are adjacent to left and right sides, respectively, of the single fork.

13. The method as in claim 12, wherein the installing step comprises bolting the fork lift shield to the single fork.

14. The method as in claim 13, wherein the bolting comprises:
positioning a fastening bar behind a vertical portion of the single fork;
extending bolts between the fastening bar and respective mounts, each of the mounts being joined to one of an outer surface of the left side portion and an outer surface of the right side portion; and
tightening the bolts to retain the fork lift shield in place in front of the inner curved portion of the single fork.

15. The method as in claim 13, wherein the bolting comprises:
positioning a U-bolt behind a vertical portion of the single fork, with ends of the U-bolt engaging respective mounts, each of the mounts being joined to one of an outer surface of the left side portion and an outer surface of the right side portion; and
tightening the U-bolt to retain the fork lift shield in place in front of the inner curved portion of the single fork.

16. The method as in claim 13, wherein the bolting comprises:
extending bolts between respective fork mounts and respective shield mounts, each of the fork mounts being joined to one of the left side and the right side of the single fork, and each of the shield mounts being joined to one of an outer surface of the left side portion and an outer surface of the right side portion; and
tightening the bolts to retain the fork lift shield in place in front of the inner curved portion of the single fork.

17. The method as in claim 12, wherein the installing step comprises using a bonding agent to retain the fork lift shield in place in front of the inner curved portion of the single fork.

18. The method as in claim 17, wherein the bonding agent is selected from a group consisting of an epoxy and a construction adhesive.

19. The method as in claim 12, wherein the installing step comprises at least one of:
inserting a protrusion, formed in an inner surface of at least one of the left and right side portions, into a recess formed in the left or right side, respectively, of the single fork; and
inserting a protrusion, formed in at least one of the left and right sides of the single fork, into a recess formed in the inner surface of the left or right side portions, respectively.

20. The method as in claim 12, wherein the installing step comprises strapping the fork lift shield to the single fork.

21. A fork lift shield for protecting an inner curved portion of a single fork of a fork lift, the fork lift shield comprising:
means for shielding the inner curved portion of a single fork of a fork lift from damage during operation of the fork lift; and
means for installing the shielding means in front of the inner curved portion of the single fork.
